(19) United States
(12) Patent Application Publication
(10) Pub. No.: US 2021/0042825 A1
(43) Pub. Date: Feb. 11, 2021

(54) Methods for Improving Investments Relating to the Purchase or Other Use of Real Property

(71) Applicant: Dunbern Holdings LLC, Portland, OR (US)

(72) Inventor: Jeffrey Dunn-Bernstein, Portland, OR (US)

(21) Appl. No.: 16/987,379

(22) Filed: Aug. 6, 2020

Related U.S. Application Data
(60) Provisional application No. 62/883,616, filed on Aug. 6, 2019.

(51) Int. Cl. G06Q 40/02; G06Q 40/06

(52) U.S. Cl. CPC G06Q 40/025; G06Q 40/06

(57) ABSTRACT

Methods for purchasing a home, investment property, or other real estate. In some embodiments, the disclosed methods may allow a purchaser of real estate to maximize, or at least clarify, several key aspects of real estate purchase and/or home ownership as it relates to the purchaser's investment strategy, net worth, and financial security, among other uses. Illustrative embodiments may allow the purchaser to increase tax savings, maximize tax deductions, shop for the best interest rate, increase the liquidity of investments, increase return on investment, acquire a higher net worth, achieve more financial flexibility, maintain a greater asset blend, protect against the potential downsides of investing in real estate, minimize exposure to loss of investments in times of market volatility in one investment class or another, and/or increase purchasing power.

### FIELD

This non-provisional utility patent application generally relates to wealth management, and more specifically to financial tools for identifying, optimizing, and reorganizing investments and assets to increase or maximize home loan qualification and mortgage approval for buyers and/or clients (or more generally referred to as “users”) who may be intending to purchase, rent, or lease a home, investment property, commercial property, or other real estate, among other uses. Additionally, aspects of the present teachings may help to maximize returns and thereby maximize net worth for such users.

### BACKGROUND

For various reasons, it may be desirable to determine an optimal and thus financially prudent method for purchasing, renting, leasing, or otherwise using a home, investment property, commercial property, or other real estate. Conventional methods for purchasing a home have generally included paying for the entire home in cash or taking out a mortgage on the home. More commonly, home buyers have combined these two methods by providing a cash down payment and financing the remainder of the price of the home through either a fixed or adjustable-rate mortgage. However, conventional methods are limited, providing the home buyer with little to no additional benefits when it comes to optimizing the home buyer's existing assets as part of an overall wealth-building strategy. Accordingly, there has developed a need for a solution that may help to identify, optimize, and reorganize all of a home buyer's relevant assets (including, but not limited to, retirement accounts) in order to maximize their purchasing power—and, in some cases, even help to maximize their returns and net worth.

While partial or majority finance based on a home buyer's resources—such as, but not limited to, assets, down payment, income, and credit—has been the norm, such conventional methods have been far from efficient in the way that such methods categorize and utilize the client's resources. Commonly, a bank or other mortgage professional may take into consideration, for purposes of mortgage approval or pre-approval, a client's credit, their stated income, and self-selected down payment. Investments and other assets held by the client have conventionally not been factored in unless expressly pledged for use in the property's financing. However, this may drastically limit a client's ability to leverage and maximize their wealth and/or obtain their desired real estate holdings. This shortcoming may be seen when examining any number of conventional mortgage calculators that simply ask for a client's income, desired down payment, and monthly bills.

(For example, a retiree may hold a significant amount of funds in their retirement account yet have little or no “income” outside of receiving social security benefits, thus greatly inhibiting the mortgage amount that a bank or lender may approve for the retiree. Due to the limitations of convention methods, the retiree may then only qualify for a smaller mortgage amount even though the retiree holds significant assets in the investment market.)

With respect to an all-cash real estate purchase, a home buyer has conventionally made the following considerations when determining whether it may be financially prudent to purchase a home outright or to finance the home: (a) opportunity cost, (b) liquidity, and (c) whether the terms of a mortgage might be favorable to the home buyer's long-term wealth-building, investment strategy, and estate planning.—First, regarding the opportunity cost of purchasing a home outright, a home buyer may consider whether the cash used to purchase the home could otherwise be invested. And, if so, whether the return on investment (such as weighing a potential eight-to-twelve percent (8-12%) return versus a four percent (4%) APR, plus a tax deduction on mortgage interest could be greater than the benefit of purchasing the home outright (such as having no monthly payments, no interest, and potentially no debt at all). For example, some home buyers may prioritize building wealth over minimizing debt, while other home buyers may prefer to live debt-free.

Second, regarding liquidity, a home buyer may consider whether they could easily move the value of their investment from one place to another, or from one investment to another. That is, if a home buyer puts a large portion of their assets into the purchase of a home, are those assets then stuck in the home, or can the value of their home be converted into other types of investments like stocks, bonds, or cash, or into another piece of real estate? And, if so, how long would those conversions take and what potential restrictions (such as, but not limited to, type of exchange and/or type of investments/assets allowed in an exchange) or ramifications (such as, but not limited to taxes and/or fees) might a client face? For example, an investor may be able to sell a stock and convert it into cash within one to two (2) days, but it might take several months or even years to sell their home or exchange it for another property. In that case, the investment of cash into or out of a home may be considered as having low liquidity.

A conventional solution to the problem of liquidity has been to open a home equity line of credit as a means to access cash or liquidity from a home. However, home equity lines of credit have generally been limited in that they have typically been offered at high interest rates, available only on a smaller portion of the home, thereby limiting the liquidity, and/or have been restrictive in how the withdrawn funds may be used. For example, those funds may not traditionally be used for investment in a different asset-class and may usually only be utilized to pay off debt or reinvest back into the current property, such as for upgrades or needed repairs.

Third, regarding mortgages, a home buyer who may otherwise purchase a home outright may consider whether it may be a better long-term strategy to finance the home—with or without a down payment. Common points of concern have generally included, for example, the interest rate that may be charged to the buyer, the length of the loan, e.g., fifteen (15) or thirty (30) years, the monthly payment of principal and interest, private mortgage insurance (PMI), the monthly escrow payment, the availability of insurance on the property/investment to hedge against loss, etc. Due to the many factors to consider, it may be desirable for a potential home buyer to consult a financial advisor or certified public accountant (CPA) for personalized guidance. However, conventional guidance regarding the investment value of purchasing a home often has stopped short of making any determinations beyond the buyer's current financial situation, the home's property value, the buyer's forecasted equity in the home, and/or perhaps strictly the income from the home such as by using it as a rental property.

Additionally, there have been numerous legal and industry-specific restrictions placed on financial advisors regarding real estate as an investment. In some countries, these restrictions have had the effect of prohibiting financial advisors from advising clients on a property or on real estate as a whole. Because financial advisors have generally not been licensed for real estate, and because real estate holdings have not been overseen and/or managed in the same way as stocks and bonds, financial advisors have been prohibited from making any kind of determination about real estate for their clients, and have merely incorporated some of the tax consequences or income as bare numbers into their financial models. At the time of this filing, there has been no licensing or any substantial professional education on the topic.

The above restrictions are some of the main problems addressed by the novel solutions presented herein. Accordingly, the methods discussed below may be valuable for home buyers, clients, and financial and tax advisors alike. Furthermore, given the large number of financing and investment options, as well as the myriad personal considerations that go into determining the most financially prudent manner in which a client should purchase a home (e.g., personal finances, projections, calculations, potential risk vs. return, asset liquidity, age, tax situation, etc.), there has developed a need for a system and method to analyze a client's preferred strategy in light of their current financial situation and financial goals, particularly for the purpose of optimizing investments and maximizing wealth in the context of purchasing a home, investment property, or other real estate.

### SUMMARY

The present teachings are directed to methods for thoroughly modeling a home or other real estate as a single investment or as part of a client's overall investment portfolio. Note that, for simplicity, a client or other user of real estate may be referred to generally as a home buyer herein, however, the present disclosure may be applicable to any suitable entity (e.g., an individual, a real estate company, an investor, etc.) desiring to engage in any suitable use (e.g., purchasing, renting, leasing, remodeling, etc.) of real property (e.g., an apartment complex, a single-family home, a commercial building, etc.).

Specifically, the disclosed methods are intended to (a) provide clients with greater flexibility and investment maximization, and (b) enable clients to potentially afford more home than available through conventional methods. Further, by combining data points to create a financial picture of the home or investment property, the present teachings enable a home buyer and/or financial professional (such as, but not limited to, an advisor, CPA, and/or banker) to accurately and mathematically measure the actual impact, financial value, true diversity, and liquidity of the desired property, compare two or more investment opportunities, and/or determine the overall financial health of the client.

As with other types of investments, real estate may have unique characteristics and features that provide both strengths and weaknesses to a client's investment portfolio and estate. Some of the desirable features of investing in real estate may include the ability to finance the investment, insure the property and/or investment, the physical nature of the investment, the dual purpose of the property as a dwelling and an asset, and the ability to update, amend, and alter the physical nature of the space and the finite or even decreasing amount of property available for acquisition and use.

On the other hand, these very same features may deter clients from investing in real estate. For example, there may be a potential for a long timeline when it comes to liquidating or selling a property; there may be significant costs resulting from needed repairs or upgrades to the home, as well as property taxes and real estate agent and other fees when selling a home; and it may be difficult to predict profits vs. loss as compared to other types of investments. Another challenge may include the lack of a regimented market or exchange for the buying and selling of real estate, as opposed to those that may be available for other investments, like stocks, bonds, or commodities. There may also be numerous potential tax and estate planning concerns that may arise.

Because these considerations may be difficult for a first-time or even seasoned home buyer or investor to navigate, clients often seek out financial professionals to provide advice on their potential real estate purchases and to help understand how these holdings might affect their net worth, retirement plan, estate planning, and so on. In order to provide this advice, financial professionals may examine not only the physical property as a unique asset from other buildings, but also the way in which the property may be used. For starters, the following considerations may drastically alter the ways that a property may exist, act, and function as an investment:
Is the client liquidating any assets to obtain the property?
   If yes:
      What are the tax consequences of the liquidated assets?
      Liquidity.
      Opportunity costs for those funds?
Is the client financing the purchase of the property?
   If yes:
      What are the types of financing available to the client? (E.g., fixed or variable rate mortgages, various mortgage durations, hard money loans, combination debt/equity contracts, etc.).
      What are the interest rates available to the client?
      How much of a down payment can the client afford?
      What counts as reportable and usable income for financing available?
      Are there any tax advantages to paying X amount vs. Y amount down?
Is the client purchasing the house outright?
   If yes:
      What are the opportunity costs?
      What are the expected returns on a given house or building?
      How do the expected returns compare to the expected returns on a different type of investment, such as stocks or bonds?
      Liquidity.
Is the client interested only in the property as a home or primary residence?
Is the client concerned with the potential growth rates associated with owning this home, or does the client want to derive income from the property? Is the client using the purchase of a home merely for diversification, or are they interested in potential tax advantages either from the home itself, the financing of the home, or even possibly from the location of the home (e.g., location in a more tax-friendly jurisdiction)? This could potentially have a much greater effect on all of the client's tax liabilities, as opposed to merely that of the real estate investment itself.

Of course, the above are merely exemplary questions that a client or their financial advisor may ask when considering the financial viability of purchasing a home, investment property, or other real estate. After a client has considered the above and/or related factors, and has decided to move forward with the purchase a home or investment property, the present teachings are intended to assist the client to best complete the purchase or the investment by providing a structured and complete analysis of all major financial considerations in order to optimize a client's Return on Investment (ROI) when purchasing real property.

More specifically, the present teachings may provide tools to ensure greater purchasing power and/or maximize a client's ability to leverage assets to include a piece of real estate and thereby maximize overall client net worth. The disclosed methods utilize two existing tools, (a) annuities or insurance and (b) asset-backed lending or a securities backed line of credit (SBLOC) in novel ways to aid clients during the home-buying process.

In some embodiments, an exemplary method for maximizing home loan qualification may include the steps of: reviewing a prequalified mortgage amount of a user (also referred to as a home buyer, a purchaser, or a client); reviewing at least one financial asset of the user that may serve as a basis for determining the prequalified mortgage amount; determining a minimum threshold for a loan-to-value (LTV) output amount of the user; calculating a final asset amount of the user based on whether the LTV output amount is above or below a minimum threshold; and calculating a new qualified mortgage amount of the user by multiplying the final asset amount of the user by a suitable factor and then adding the resulting amount to the at least one financial asset of the user.

In some embodiments, the at least one financial asset of the user may include an income of the user suitable for determining the prequalified mortgage amount. In such embodiments, the at least one financial asset of the user may further include a bank account of the user, an investment account of the user, an annuity of the user, and/or an insurance policy of the user. In some embodiments, the method may include another step of determining a risk score or tolerance of the user. In such embodiments, the risk score or tolerance may be used to determine a suitable asset blend in a non-qualified or qualified account of the user. In some embodiments, the method may include a further step of reviewing at least one of an account holding of a user, an investment portfolio of a user, or an asset blend of the user. In some embodiments, it may be useful to produce a comparison of at least two different methods of financing a home so that the user can make an informed decision about how to purchase the home.

In some embodiments, an exemplary method for maximizing mortgage approval may include the steps of determining whether a user has at least one initial asset sufficient to purchase a desired property in cash; determining whether the user may be capable of qualifying for a mortgage on the desired property; determining an end value of the desired property compounded over a term of the mortgage; identifying an interest rate, a monthly payment, and a total number of payments on the mortgage over the term of the mortgage or any point throughout; estimating an amount of tax savings based on an anticipated amount of tax deductions for the interest rate of the mortgage over the term of the mortgage; compounding the amount of tax savings at a suitable rate associated with a portfolio asset blend of the user; and identifying a total mortgage amount anticipated to be paid over the life of the mortgage.

In some embodiments, such methods may further include a step of compounding the at least one initial asset of the user over the term of the mortgage or up to any point throughout. In some embodiments, there may also be a step of identifying an estimated amount of property taxes due on the desired property over the term of the mortgage or up to any point therein. In some embodiments, there may be a step of collecting a set of financial information from the user in order to run a mortgage report for the user. In such embodiments, the mortgage report may serve as the basis for determining the interest rate, monthly payment, and/or the total number of payments on the mortgage for the desired property. Some embodiments may include an additional step of using the mortgage report to determine whether it may be more financially prudent for the user to complete a purchase of the desired property outright or, alternatively, to finance some or all of the purchase.

In some embodiments, exemplary methods of increasing real estate loan approval may include the steps of determining at least one financial asset held in at least one investment account of a user; using the at least one financial asset of the user to determine whether the user may be capable of receiving a mortgage approval on a desired property; using asset-backed lending or SBLOC to increase the mortgage approval for the user on the desired property; and keeping the at least one financial asset of the user within the at least one investment account of the user when the user purchases the desired property.

In some embodiments, the set of financial data of the user may further include the user's annual income, desired down payment, and/or an amount of monthly expenses (such as bills and/or other overhead) of the user. In some embodiments, the asset-backed lending or SBLOC may enable the user to purchase the desired property without ever having to remove the at least one financial asset from the investment account, i.e., without taking the user's investment(s) out of the market. This may also result in avoiding taxable events for the user.

In some embodiments, there may be an additional step of at least temporarily placing the at least one financial asset into an annuity to provide “guaranteed” income for the user. In such embodiments, the “guaranteed” income may be annuity income that may be determined by the carrier of the annuity. In such embodiments, there may be a further step of removing the at least one financial asset from the annuity and then placing it into a suitable blend in a qualified or non-qualified account of the user. In some embodiments, it may be useful to combine a compounded asset total for different purchase methods for a comparison that may help the user make a prudent financial/investment decision. It may be important to note that, depending on the user's age and even potentially the user's health or sex, along with a number of other factors such as the type of insurance or annuity product that may be used, there may be an inability to use one product over another as well as benefits and restrictions to utilizing either a “free withdrawal” feature or the annuitization of a product in any given scenario. All of these factors may play an important role in not only maximizing this process' value to the client or user but also may be dealt with diligently as to ensure the client may not be harmed or disadvantaged.

In some embodiments, the described methods may be used to significantly increase the purchase price of a home for which a client may be qualified. In some embodiments, the described methods may be used to determine whether the client may be more likely to maximize their wealth by purchasing the home outright or by taking out a mortgage. And, in some embodiments, the described methods may be used to help a client analyze the viability of using a piece of real estate as an investment property or to compare two different properties or more to one another for investment viability.

Although the present disclosure may be used in various applications, the prevailing theme across all embodiments may be to identify and maximize key aspects of real estate purchase and finance as it relates to investments, net worth, and financial security for home buyers and/or real estate investors. Examples of such key aspects include tax savings or maximizing tax deductions, comparable interest rate shopping, greater liquidity of assets, higher potential ROI, higher potential net worth, more flexibility, greater asset blend, investment diversity, and better potential downside protection of real estate assets and total net worth, lower exposure to real estate or investment loss during times of volatility in one or more investment classes, and greater real estate purchasing power. Or, in some cases, the evaluation of a given property and its potential to be a worthwhile investment or the comparing of two or more properties to determine which may be the best investment.

### BRIEF DESCRIPTION OF THE DRAWINGS

FIG. 1 is a graph showing an exemplary home loan approval that may be achieved for a client, according to aspects of the present disclosure.

FIG. 2 is a graph showing some potential benefits of financing a property over paying cash, according to aspects of the present disclosure.

FIG. 3 is an illustration showing the conversion of a client's risk score into a suitable blend, which then determines the client's potential loan-to-value ratio (LTV), according to aspects of the present disclosure.

FIG. 4 is an illustration showing figures that a client may input into the investment calculator in order to determine their home loan qualification and projected net worth over time, according to aspects of the present disclosure.

FIG. 5 is an assets based report showing a visualization of the client's home loan qualification, based on their annual income, down payment on a home, monthly bills, retirement accounts, investment accounts, and bank accounts, according to aspects of the present disclosure.

FIG. 6 is a flowchart showing a method for determining home affordability or maximizing the loan amount that a client may be prequalified for, according to aspects of the present teachings.

FIG. 7 is a flowchart showing a method for comparing a client's net worth based on an all-cash home purchase compared to financing the home purchase, which may serve to inform the present teachings but is not intended to limit the present teachings.

FIG. 8 is a flowchart showing a method for determining a client's net worth based on methods described herein, according to aspects of the present teachings.

FIG. 9 is a flowchart showing a method for understanding the use of certain real property as an investment, according to aspects of the present disclosure.

### DETAILED DESCRIPTION

### Overview

Various embodiments of methods for optimizing investments and maximizing returns for clients who may be intending to purchase a home, investment property, or other real estate described below and shown in the associated drawings. Unless otherwise specified, the disclosed methods may, but are not required to, contain at least one of the components, steps, functions, and variations described or shown herein. The following description of various embodiments is merely exemplary in nature and is in no way intended to limit the disclosure, its application, or uses. Additionally, the advantages provided by the embodiments, as described below, are illustrative in nature and not all embodiments provide the same advantages or the same degree of advantages.

### 1. General Features

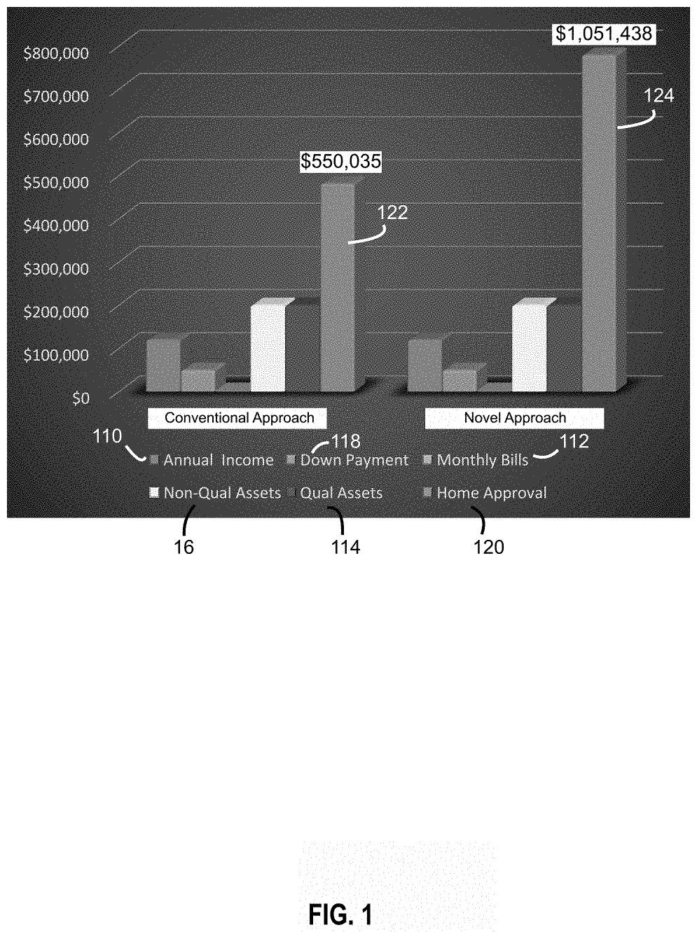

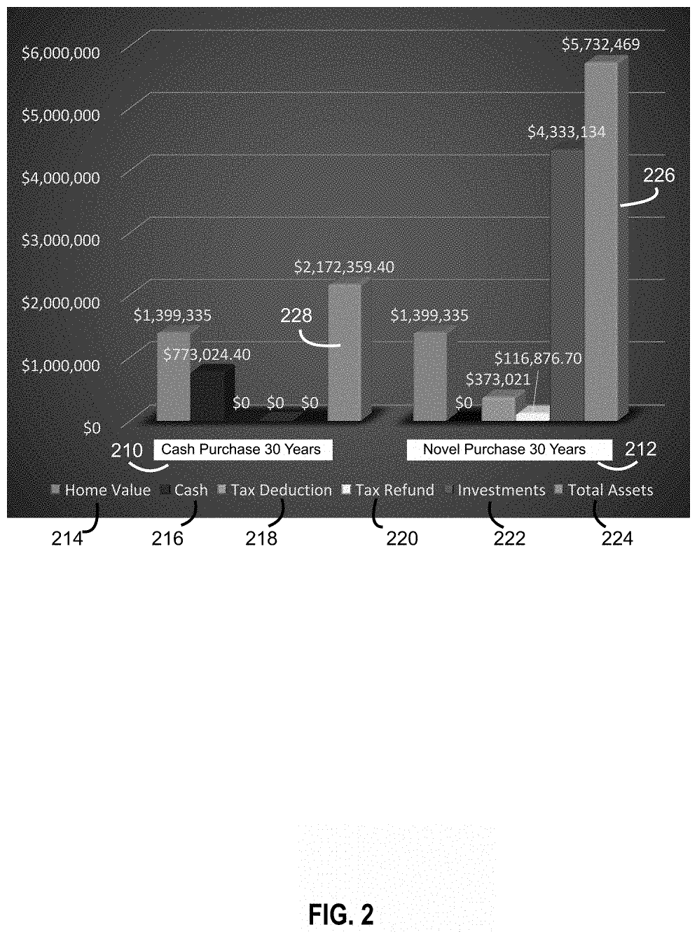

This section describes general features of investment optimizing methods, according to aspects of the present teachings; see FIGS. 1-2.

FIG. 1 is a graph showing an exemplary home loan approval that may be achieved for a client, according to aspects of the present disclosure. Generally, a mortgage lender may review financial information of a client in order to determine the amount of home that the client can afford, i.e., the maximum amount of money toward a home purchase that the lender might be willing to finance combined with the client's desired or pledged down payment. The factors include, without limitation, the client's annual income 110, monthly bills 112, qualified assets 114, non-qualified assets 116, and the amount of down payment 118 that the client may be able to pay.

By way of example and not limitation, as shown in FIG. 1, a client having financials of $120,000 in an annual income 110, $50,000 in a down payment 118, $700 in monthly bills 112, $200,000 in non-qualified assets 116, and $200,000 in qualified assets 114, may be approved for a conventional approval 122 of up to, say, $550,035 based on conventional approval methods. However, with those same financials, the very same client may be approved for a novel approval 124 of up to, say, a $1,051,438 property based on methods disclosed herein. That is, by using two (2) main financial tools: (a) annuities or insurance and (b) asset-backed-lending, there may be a potential to increase the mortgage approval for a client, without ever requiring the client's assets to leave their investment accounts.

More specifically, with asset-backed lending or an SBLOC, the described methods enable a client to maintain balances invested in the market, in their client account(s), while still utilizing a percentage of the client's assets as a potential down payment in an amount greater than what the client would otherwise desire to liquidate if using a traditional down payment, and without creating a potentially taxable event or tax liability for the client with liquidation. To further enable the client to qualify for a better mortgage, the client may also temporarily place their money into an annuity to provide “guaranteed income” for the client. This is discussed in further detail below.

The following illustration is intended to illustrate why the disclosed methods may favorably compare with traditional methods or a cash purchase. For example, the rate of return for the United States housing market (as represented by the Case-Shiller national housing index) for a particular year may be 3.6%. In contrast, a 70/30 blend of the most common equity and bond ETF funds using the presently described system and methods may, in some cases, allow for a rate of return of 8.47%—much higher than the returns a client may enjoy from the appreciation of a single-family home.

To further explain the exemplary 70/30 blend, “70/30” refers to a blend of seventy percent (70%) equities and thirty percent (30%) bonds. A 70/30 blend has been common in portfolio construction and may therefore be useful for describing the present methods. However, any suitable blend (such as 50/50, 80/20, etc.) may be used. Based on the specific type of investment blend, an asset-backed lender may determine a loan-to-value ratio (LTV). Bancorp, for example, would assign a 70/30 blend with an LTV of fifty-nine percent (59%). This percentage may be reached using the lender's willingness to loan fifty percent (50%) on equities and eighty percent (80%) on bonds. The weighted averages in this illustrative portfolio may then lead to a combined weight of a 59% LTV.

Note that the above illustration is merely intended to show that financing may be better than paying cash in some situations. Although what is represented above may provide some of the underpinning logic on which the present disclosure is based, this is merely to provide two (2) exemplary rates of return and is not intended to limit the potential accomplishments made possible by the present teachings. In other words, said illustration is intended to serve as building block to understanding the inventor's approach in inventing the disclosed methods, but not at a limitation on the potential results of said methods.

FIG. 2 is a graph showing an example of some potential benefits, over thirty (30) years, of using traditional financing methods over purchasing a property outright for cash—referred to in FIG. 2 as Cash Purchase 30 Years 210. For illustration purposes, it may be useful to compare the purchase of a $500,000 home with cash versus obtaining a traditional mortgage versus using the novel methods disclosed herein—the latter being referred to as Novel Purchase 30 Years 212. This example assumes that the client has the funds to purchase the home in cash, as well as the income needed to cover the mortgage at 100% financed if required. This example may also assume that the cash is liquid (as opposed to being bound up in investments, which would need to be liquidated and potentially have tax consequences for the client).

These assumptions, although representing two (2) extremes that may not often be utilized, allow for the consideration of potential outcomes on both extreme ends, as well as any number of variations falling somewhere between an all-cash purchase and 100% financing. In some embodiments, useful financial data pertaining to a client may include home value 214, cash 216, tax deduction 218, tax refund 220, investments 222, and total assets 224. Because the home may be paid for in cash and the income that may have otherwise been used to pay for the mortgage may be allowed to accumulate as cash over thirty (30) years, and because the value of the home may increase each year, the “cash purchase” net worth after thirty (30) years can be calculated.

As shown in FIG. 2, the present methods may result in a much higher novel net worth 226 for the client at the end of a 30-year mortgage term, as opposed to a conventional net worth 228 at the end of the same term. That is, using conventional mortgage calculators that may be publicly available on the Internet, FIG. 2 compares the purchase of a $500,000 home with cash to using traditional methods of financing. This may not only be useful when looking at the various options that may be available when purchasing real estate, but may also be paramount when undertaking financial and estate planning. The drastic differences in potential outcomes for liquidity, taxation, diversification, and net worth may be of such import that it may be considered a breach of fiduciary duty (if one exists) to not examine them for a client.

As shown by Cash Purchase 30 Years 210 in FIG. 2, if the home value 214 may be allowed to increase year by year by the historical national average, one can estimate the conventional net worth 228 after thirty (30) years. As shown in Novel Purchase 30 Years 212 of FIG. 2, by contrast, this example assumes that the client may have the ability to finance the property purchase at 100%, using their income and leaving all of their investments 222 invested in the market in our exemplary blend of 70/30 and net of fees (in this example, an annual 1.25% charged by the financial advisor). Using the client's income to pay the mortgage for thirty (30) years, instead of paying cash, the home may appreciate the same amount as when making an all-cash purchase.

However, using methods disclosed herein, there may also be a return of the 70/30 blend on the client's portfolio of investments 222 that may be allowed to grow undisturbed for the thirty (30) year term of the mortgage. In this example, the investments 222 may be left to appreciate at their historical average. Interest rate drags and fees may be subtracted where applicable. There may also be tax savings, such as a tax deduction 218 and/or tax refund 220, on the mortgage interest that lead to savings that may then be available to be invested into the market as they are realized and thus may result in additional returns for the client.

Note that property taxes for Portland, Oreg. have been taken into account in Novel Purchase 30 Years 212 shown in FIG. 2 but have not been subtracted in the cash purchase example as additional calculations may be desirable to perform. This may lower the ending net worth or total assets 224 of the cash buyer by even more in comparison to the financing of the home. A preferred embodiment may perform all desirable mathematical functions automatically to provide an accurate picture for the client and/or financial advisor. The variations on the financing purchase model may add up to a much higher net worth for the client at the end of a thirty (30) year mortgage, as shown by the total assets 224 in FIG. 2. Note, however, that a thirty (30) year mortgage term is merely used as an example herein. The disclosed methods may be used with any desirable mortgage term.

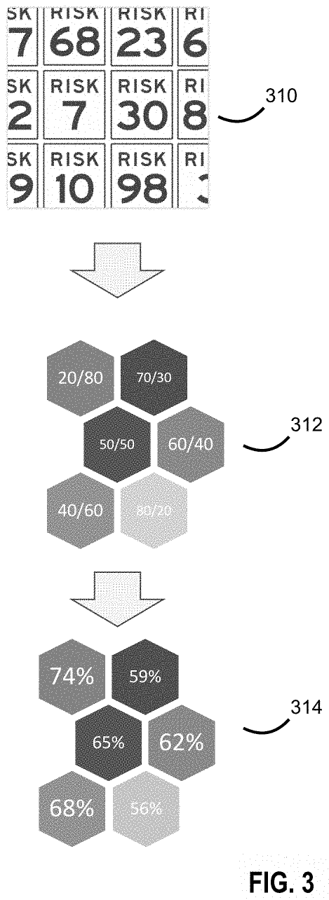

FIG. 3 is an illustration showing the conversion of a client's risk score 310 into a suitable blend 312, which then determines the client's potential loan-to-value ratio (LTV) 314, according to aspects of the present disclosure. Note that this illustration uses a program called Riskalyze. Of the many existing programs for calculating a client's risk score, Riskalyze may be popular in the public marketplace, but numerous other programs exist in this space as well as countless proprietary versions that may be specific to the various advising firms and/or broker dealers. Any suitable such program may be used. Using any suitable test, program, or process to determine an appropriate risk for a client may help the client and/or their financial advisor understand and document the risk tolerance or risk score 314 of that client, and thereby may help the financial advisor to determine one or more appropriate blend 312 and/or investment goals for the client.

Using a suitable program such as Riskalyze may enable a client and/or financial advisor to gather information on how the client may view investing and thus gain insights into appropriate levels of risk versus reward for that client. This may help the client and/or financial advisor determine whether a suitable blend 312 of assets may be 80/20, 70/30, 50/50, etc. Riskalyze, for example, may provide guidance on which blends may be potentially appropriate based on the client's answers to certain prompts. Common questions that may help determine a certain client's risk tolerance may include, for example: age; next major expenditure of money (e.g., starting a new business, paying for college tuition, planning for retirement, etc.); when the client may expect to use most of the money they may now be accumulating in their investments, their investment horizon (e.g., 5 or 20 years from now); whether the client expects their income to grow, decrease, or stay the same; how the client might react to a downturn in the market; etc. Once an appropriate risk score 310 and suitable investment blend 312 are determined, that blend may be translated into a probable LTV ratio 314 or maximum loanable amount on those non-qualified assets that the client possesses.

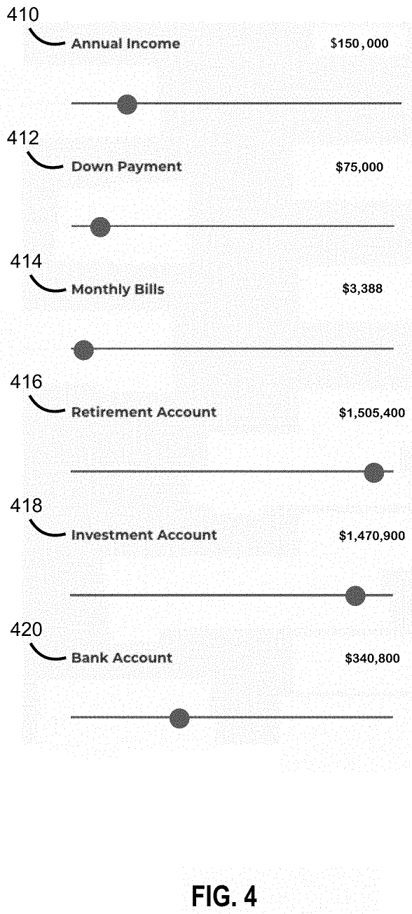

FIG. 4 is an illustration showing exemplary financial data that a client may input into the various fields of an investment calculator in order to determine their home loan qualification and projected net worth over time, according to aspects of the present disclosure. These numbers include, for example, and not by way of limitation: the client's annual income 410, a desired down payment 412 that the client may have initially set aside to pay on the house, the client's monthly bills 414, the total assets in the client's retirement account(s) 416, the total assets in the client's investment account(s) 418, and/or the total amount of cash that may be in the client's bank account(s) 420, or that may be available from other sources, such as gifts from family, etc. Note that different embodiments may include different financial data, depending on what type of funds may be available to a particular client.

In the example shown in FIG. 4, a client's exemplary financial information may be input as follows: an annual income 410 of $150,000; a down payment 412 of $75,000; monthly bills 414 equaling $3,388; assets in retirement account(s) 416 in the amount of $1,505,400; assets in investment account(s) 418 in the amount of $1,470,900; and cash in bank account(s) 420 in the amount of $340,800. Some embodiments may include an investment calculator that automatically calculates the mortgage that a client may be approved for after the client inputs their financial information, such as by using text boxes and/or sliders of the investment calculator on an app or website. Clients may also tinker with the numbers to determine how much, for example, a client may need to save in their bank account 420 before qualifying for a desired home loan amount. In some embodiments, the investment calculator may be used as a tool for setting and monitoring progress on financial goals.

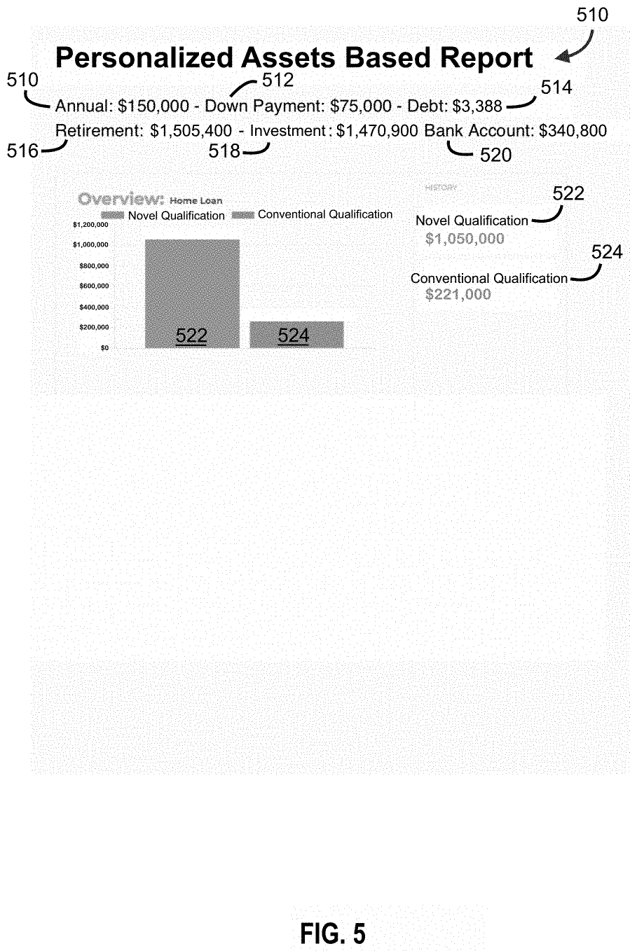

FIG. 5 is a personalized asset based report 510 showing an exemplary visualization of client's home loan qualification based on their annual income 510, initially planned down payment 512, debt or monthly bills 514, retirement account(s) 516, investment account(s) 518, and bank account(s) 520, according to aspects of the present disclosure. In some embodiments, the client's potential future net worth may also be displayed based on the current disclosed assets and home values, with or without a visual comparison between methods disclosed herein (i.e., novel home loan qualification 522) and conventional or alternatively selected methods (i.e., conventional home loan qualification 524).

In some embodiments, the report shown in FIG. 5 may be automatically generated after a client inputs the financial information requested in FIG. 4. As shown in FIG. 5, a client with an annual income 510 of $150,000, who may be capable of making a $75,000 down payment 512, has $3,388 in monthly debt or bills 514, $1,505,400 in their retirement account(s) 516, $1,470,900 in their investment account(s) 518, and $340,800 in their bank account(s) 520 may only qualify for a $221,000 mortgage using conventional methods—visualized here as conventional home loan qualification 524. In comparison, the same client with the same financials may be able to qualify for a much larger novel home loan qualification 522 of $1,050,000, if using the methods disclosed herein. Note that these numbers are merely exemplary, and the increase of a potential home loan qualification may vary, depending on numerous financial and/or economic factors. Additionally, not all embodiments may show a comparison between conventional and novel methods.

Although not shown in FIG. 5, some embodiments may include a projection of the client's net worth based on the financial information they input into the investment calculator. For example, a client who inputs the financial information shown in FIG. 5 may have a projected net worth of X amount in thirty (30) years, according to the methods disclosed herein. Meanwhile, the same client with the same financial information may have a project net worth of a much lower Y amount over thirty (30) years if that client were to purchase and/or finance their home and invest using conventional methods. The purpose of this visualization, if included, may be to aid the client and/or financial advisor to make a better-informed decision regarding the contemplated real estate purchase.

As indicated in FIG. 5, using annuities and asset-backed lending as part of a client's real estate purchase and overall investment strategy may result in a qualifying for a much higher home loan and/or achieving a much higher net worth than if using conventional methods, even with the same financial information. More specifically, these results may be achieved by adding additional income and down payment without ever removing the client's actual investments from their respective accounts. This may provide a straightforward, enhanced ability to afford real estate having higher value.

Note, however, it has traditionally been a mortgage lender that approves a client for their mortgages—not a financial advisor or the client themselves. Rather, a financial advisor may help a client achieve their goals by sending available down payment numbers approved by Bancorp, for example, who may decide the loan to value ratio (or LTV) and write the check and additional income in the form of annuity income that may be determined by contract between the carrier and the client. These additional down payment and income amounts may then be taken into account by a mortgage broker or loan officer to offer the client a mortgage.

Based on the specific type of investment blend, lenders such as Bancorp may determine the LTV, such as fifty-nine percent (59%) for a blend of seventy percent (70%) equities and thirty percent (30%) bonds. This number may be reached using Bancorp's willingness to loan fifty percent (50%) on equities and eighty percent (80%) on bonds. The weighted averages in this exemplary portfolio may lead to a combined weight of a fifty-nine percent (59%) LTV. In some embodiments, it may be useful to review the market performance of the 70/30 blend over time, including the drag from advisory fees as well as from the interest rate that may be charged by Bancorp (or any other suitable lender) on the maximum borrowed assets. This may be looked at when borrowing all of the fifty-nine percent (59% LTV), just fifty percent (50%) of the available fifty-nine percent (59%) LTV, or any other suitable amount of the total LTV.

Note that, although any asset-backed lending partner may be suitable for the methods disclosed herein, Bancorp may be used as an example because, at the time of this filing, it currently has suitable rates and standards for which investments qualify, as well as for what loan to value they would be allowed to utilize.

### Examples, Components, and Alternatives

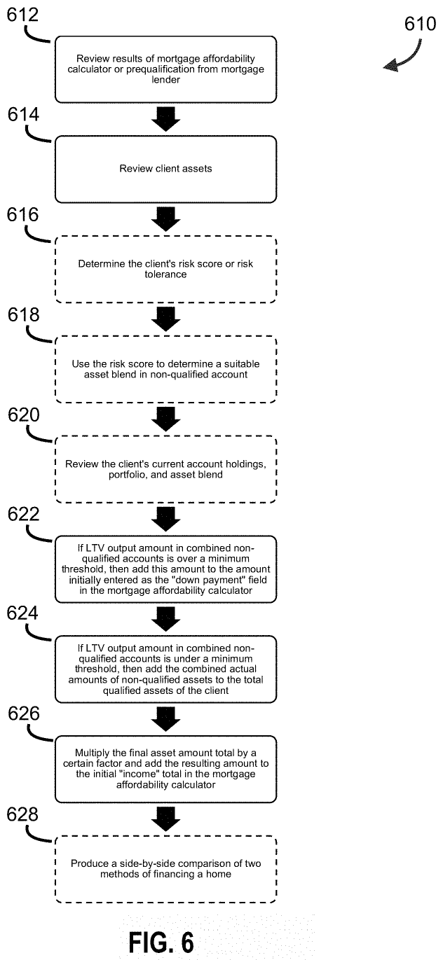

The following sections describe selected aspects of exemplary methods for optimizing investments in the context of purchasing real property; see FIGS. 6-9. The examples in these sections are intended for illustration only and should not be interpreted as limiting the entire scope of the present disclosure. Each section may include one or more distinct inventions, functions, and/or steps.

1. Home Affordability and/or Prequalification Maximization

FIG. 6 is a flowchart showing an exemplary method 610 for determining home affordability and/or increasing or maximizing the loan amount that a client may be prequalified for, according to aspects of the present teachings.

As shown in FIG. 6, some embodiments may include a first step 612 of reviewing a client's results of a mortgage affordability calculator or prequalification from a mortgage lender; a second step 614 of reviewing the client's assets; an optional third step 616 of determining the client's risk score or risk tolerance; if performing the third step 616, then performing an optional fourth step 618 of determining a suitable asset blend for the client; if performing the third step 616 and fourth step 618, then performing an optional fifth step 620 of reviewing the client's current account holdings, portfolio, and asset blend; a sixth step 622 and/or seventh step 624 that may involve reviewing the client's LTV output; an eighth 626 step of multiplying the final asset amount by a certain factor and adding the resulting amount to the client's “income” value; and an optional ninth step 628 of producing a side-by-side comparison of two different methods of purchasing a home. Some embodiments may also include a potential reallocation of a client's investments to either return them to a blend that may be most suitable for their normal risk tolerance or, if directed by the client, more beneficial use with asset-backed lending criteria in order to afford more real estate or achieve more favorable terms.

More specifically, in some embodiments, the first step 612 of a method 610 to increase and/or maximize the amount of home that a client may be prequalified for, may be reviewing the results of the client's mortgage affordability analysis (such as by using a mortgage affordability calculator readily available online) or a prequalification report from a mortgage lender. A second step 614 may then be to review the client's assets, such as, but not limited to, assets in qualified accounts, non-qualified accounts, annuities, insurance products, and bank accounts. In some embodiments, the client or their financial advisor may input these amounts into a software-based investment calculator that may automatically analyze the assets.

In some embodiments, such as where a financial advisor may be acting as a fiduciary, it may be desirable for the advisor and/or client to perform an optional third step 616 of completing a risk tolerance questionnaire or utilizing a similar method to determine an appropriate risk level or risk score of the client. In some embodiments, an optional fourth step 618 may include using the client's risk score to determine a suitable client asset blend in non-qualified accounts. For example, a suitable asset blend may be 70/30, i.e., seventy percent (70%) equities (stocks, ETFs, and mutual funds) and thirty percent (30%) debt (bonds, bond funds, or bond ETFs). However, asset blends may vary from client to client, depending on their risk tolerance and other financial factors.

After determining a suitable asset blend for the client, it may be desirable to include a fifth step 618 of reviewing the client's current account holdings, portfolio, and asset blend. In some embodiments, it may be useful to determine the total loan-to-value (LTV) potential for the client's non-qualified portfolio(s). In some embodiments, for example, this may be accomplished by multiplying the equity investments by a factor of 0.5 and the debt investments by a factor of 0.8. In this example, the LTV would be fifty-nine percent (59%) on the total non-qualified portfolio of the client. These factors are provided for illustrative purposes only, as actual numbers may vary between different clients depending on their financial information and goals, as well as by the guidelines of various institutions that may potentially be utilized in the issuing of asset-backed lines of credit, such as—but not limited to—BNY Melon, Bancorp, Goldman Sachs, etc.

In preferred embodiments, the investment calculator (which may be web-based or software-based and easily accessible to the client or financial advisor such as by using a computer or smart device) may automatically determine a recommended asset blend and/or automatically populate LTV percentage based on the client's risk score. Once the LTV percentage is determined, it may be desirable to multiply the client's combined non-qualified assets by the LTV percentage to determine a monetary amount. In preferred embodiments, the investment calculator may automatically determine a maximum LTV amount when the asset blend is input into the calculator.

In some embodiments, an appropriate next step may then be to determine whether the LTV output amount is over a certain minimum threshold, i.e., the current minimum initial withdrawal from a particular type of asset-backed line. For example, this minimum threshold may be $75,000 USD or whatever amount may be current at the time of performing this step. Thus, for a sixth step 622, if the LTV output amount is over the minimum threshold, then the LTV output amount may be added to the amount initially entered in the client's “down payment” field on the mortgage affordability calculator, or into the prequalification math performed by the mortgage lender. In preferred embodiments, the investment calculator may perform this step automatically. In such embodiments, the investment calculator may be updated periodically when the minimum threshold changes. For example, in some circumstances, the minimum threshold may be higher or lower if some accommodation of scale can be agreed to with a particular lending institution.

In some embodiments, it may be useful to multiply all combined non-qualified assets by the LTV percentage to determine whether the LTV output amount is over or under the current minimum threshold. Note that, in some embodiments, this step may be performed substantially in conjunction with the sixth step 622 above, or the order of the steps may be reversed. If the LTV output amount from combined non-qualified amounts is under the current minimum threshold, then instead of the sixth step 622, it may be desirable to perform an alternative seventh step 624 the combined actual amounts of non-qualified assets may be added to the total qualified assets of the client. In preferred embodiments, the investment calculator may perform this step automatically.

In some embodiments, the appropriate next step may depend on whether the LTV output amount is over or under the minimum threshold, as determined in the previous step(s) of the exemplary method 610. For example, an eighth step 626 may be to multiply the final asset amount total (i.e., the qualified assets or the qualified assets plus non-qualified assets, depending on whether the LTV output amount is over or under the appropriate minimum threshold) by a factor of, say, 0.2, or add the resulting amount to the initial figure input as the client's “income” in the mortgage affordability calculator or in the prequalification math that may be performed by the mortgage lender. In preferred embodiments, the investment calculator may perform this step automatically.

Note that the multiplication factor of 0.2 or twenty percent (20%) used herein is merely an example and is not intended to be limiting. In certain situations, it may be appropriate to use a smaller or larger factor instead. It may be important to note that the ability to use a specific insurance product may reduce certain options available to the home buyer, client, and/or financial advisor, such as by limiting the number of carriers available. In some situations, the age of the real estate purchaser may also affect which products may be available to or may be most suitable for the purchaser. The available income that can be generated for the purchaser may also be affected by the type of account or accounts that the assets may be held in. Accordingly, the appropriate multiplication factor (such as 0.1, 0.2, 0.3, etc.) may be different from purchaser to purchaser.

In some embodiments, limiting a maximum percentage of a client's assets in any single investment such as an insurance or annuity product to fifty percent (50%), for example, may serve as a safeguard to ensure that an advisor or insurance agent may not be placing too great a percentage of a client's assets into an overly concentrated and/or potentially less liquid investment and thereby generating commissions for the advisor or agent. It may thus be a general rule, depending on the firm or broker-dealer, that an advisor or insurance agent may not place more than between thirty-to-fifty percent (30%-50%) of a client's total assets into annuities. There may be exceptions and ways to add more investment into this category, but using fifty percent (50%) as a general rule may be safe and potentially more appropriate for a fiduciary. It should also be noted that different carriers, RIAs and broker dealers, may have limits lower than the fifty percent (50%) used in this example. However, for purposes of illustration, this example may assume the use of a five (5) year Single Premium Immediate Annuity (SPIA). Note that the SPIA in this example with a twenty percent (20%) annual payout may cause a taxable event where as something like a ten percent (10%) or fifteen percent (15%) free withdrawal provision probably would not, especially if moved back to a qualified account at distribution.

Next, in some embodiments, an optional ninth step 628 may be to produce a side-by-side comparison of at least two (2) methods of purchasing a house, such as conventional financing methods versus methods described herein. Performing this step, although optional, may be desirable to show the client the potentially drastic improvements to their mortgage qualification that may be possible with novel methods present herein, such as by increasing and/or maximizing the amount of home (i.e., the price of a home) that the client may qualify or prequalify for, and without requiring any changes to the client's current taxable income, savings, investment strategy, taxes, etc.

2. Cash Purchase vs. Financing: Net Worth

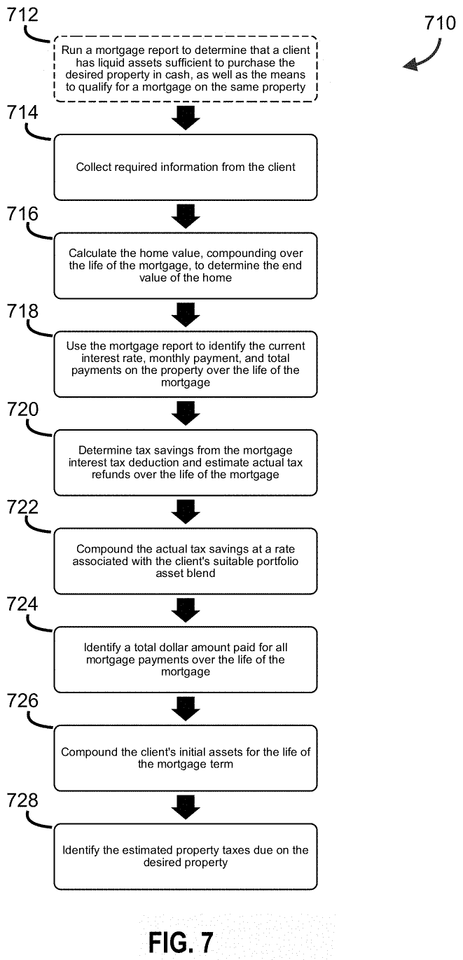

FIG. 7 is a flowchart showing an exemplary method 710 for comparing a client's net worth based on an all-cash home purchase compared to financing the home purchase, which serves to illustrate the present teachings but is not a required result thereof and thus not intended to be limiting.

As shown in FIG. 7, some embodiments may include an optional first step 712 of running a mortgage report for the client; a second step 714 of collecting required financial information from the client; a third step 716 of calculating the value at the end of a given term, such as thirty (30) years, of the potential property that the client may be interested in purchasing; a fourth step 718 of using the mortgage report (if having completed the optional first step 712) to identify the current interest rate, monthly payment, and total payments on the property over the life of the mortgage; a fifth step 720 of determining tax savings from the mortgage interest tax deduction and estimating the actual tax refunds over the life of the mortgage; and a sixth step 722 of compounding the actual tax savings at a rate associated with the client's reported income and corresponding tax bracket.

Although not shown in FIG. 7, some but not embodiments may include a next step of adding the yearly tax refund amount to the client's investment portfolio, followed by yet a next step of identifying a total dollar amount paid or potentially paid over the life of the mortgage. As shown in FIG. 7, an exemplary method 710 may include a ninth step 726 of compounding the client's initial assets over the life of the potential mortgage term; and a tenth step 728 of identifying the estimated property taxes due on the property and either including them in the payments on the property over the term or subtracting their total amount from the ending net worth of the client. Other embodiments may include more or less suitable steps, and these steps in many cases can be performed in different sequences.

The exemplary method 710 shown in FIG. 7 may, in some cases, be suitable for a client who (a) may own liquid assets sufficient to purchase a desired property in cash and (b) may have the means to qualify for a mortgage (or other financing) on the same property and may receive income sufficient to make all required payments for the property and associated costs with a minimal or zero (0) down payment.

To determine whether the above statements may be true for a particular client, it may be desirable to perform the otherwise optional first step 712 of running a mortgage report to determine the cost of the desired property for the client, and whether it may be more financially prudent for the client to purchase the property outright or finance some or all of the cost. In some embodiments, the client may be able to select a myriad of “in-between” options, such as by putting a particular amount of cash down and financing some of the purchase to avoid private mortgage insurance, have more immediate equity, or because the client may be at or over the limit for federal deductions and would not move to a lower tax bracket with additional down payment. Some embodiments may depict strategically utilizing annuities and asset-backed lending as part of the client's real estate purchasing strategy in order to maximize overall net worth or returns.

In some embodiments, the second step 714 may be to collect and/or document financial information relevant to the client. This may include, for example, the amount of liquid assets of the client (e.g., cash and investments in non-retirement accounts); the cost to purchase the client's desired property; the property taxes on the desired property; the client's income, tax bracket, and mortgage interest rate; the average investment rate of return on a suitable portfolio blend for the client; and the average rate of return on homes for the previous corresponding term, e.g., fifteen (15) or thirty (30) years or expected returns based on other factors.

In some embodiments, the third step 716 may then be to calculate the value of the home, compounding over the life of the potential mortgage (such as, for example, a 30-year fixed rate mortgage), using historical averages for the area where the property may be located, or using the U.S. national average. This calculation may provide an approximation of an expected home value at the end of the mortgage term, which, for simplicity, may be referred to as the “end value.” In preferred embodiments, the investment calculator may automatically determine the end value of the home.

Next, in some embodiments, the fourth step 718 may be to use the mortgage report generated in the first step 712 to identify the current interest rate, monthly payment, and/or total payments on the desired property over the life of the mortgage. In some embodiments, the fifth step 720 may be to determine the tax savings from the mortgage interest tax deduction, based on the interest rate on the mortgage, the purchase price of the home, and the client's income tax bracket. In preferred embodiments, the investment calculator may perform this step automatically. This step may then provide the client or financial advisor with the estimated tax deduction information for the client, as well as an estimate of actual tax refunds over the life of the mortgage, subject to legal limits.

After identifying the client's actual tax savings, the sixth step 722 may be to compound the tax savings at the rate associated with the client's suitable portfolio asset blend, starting with year one (1) net tax savings returned to the client and adding additional funds annually as they are earned. In some embodiments, the seventh 724 step may be to identify the total dollar amount paid toward the mortgage over the life of the mortgage. In some embodiments, the eighth step 726 may be to compound the client's initial assets by the life of the mortgage term, e.g., thirty (30) years, at the growth rate associated with the client's suitable portfolio asset blend. Then, in some embodiments, the ninth step 728 may be to identify the property taxes due on the desired property and, for cash purchases, subtract it from the ending net worth of the client.

Note that, in some embodiments, it may be suitable to consider the various potential growth rates of gains in various assets, subtract the drags (or negative interest rates), and compare the various nets to generate the most favorable outcome for the client based on their capability or assets. An example of this may be the expected increase in home value, subtracted by the mortgage interest rate, plus the return of tax dollars, combined with investment growth, subtracting the ABL drag. A general concept here may be to compare (a) what can be accomplished with a given amount of money based on where it may be invested, with (b) the net outcomes for each segment.

Additionally, although not shown in FIG. 7, a potential tenth step may be to determine the client's forecasted or estimated net worth at the end of the mortgage term or any other amount of time. If the client might purchase the property in cash, then this step may include adding the estimated end value of the property to the total sum of the mortgage payments that would have been paid from income (either held in cash or periodically invested back into a different asset class) over the life of the term, and then subtracting the estimated property taxes to result in an estimated net worth for the cash-buyer client at the end of the mortgage term.

If the client may be, however, opting to maintain custody of at least some of their liquid assets or investments then compounding both the property's value as well as the investments over the term may be appropriate to calculate a likely ending net worth. If the client might utilize annuities and asset-backed lending as part of the client's property purchasing strategy, then an alternative tenth step may be to add the estimated end value of the property to the net cash tax savings after systematic investment and compounding the end value of the initial home cost over the term of the mortgage at the appropriate interest rate. In preferred embodiments, the tenth and/or further steps may be performed automatically by the investment calculator.

Note that, in some embodiments, a visual comparison of making an all-cash payment or financing the home may not consider any of the client's additional purchase power that might be afforded by using annuities and asset-backed lending. Rather, such embodiments may merely demonstrate the opportunity cost, and may assume that a client can pay for the home using either cash or financing. The present example assumes that all of the $500,000 may be invested over the term of the thirty (30) year mortgage in a 70/30 blend net of fees. However, other embodiments may take other relevant numbers and factors into account.

3. Maximizing Approval: Net Worth

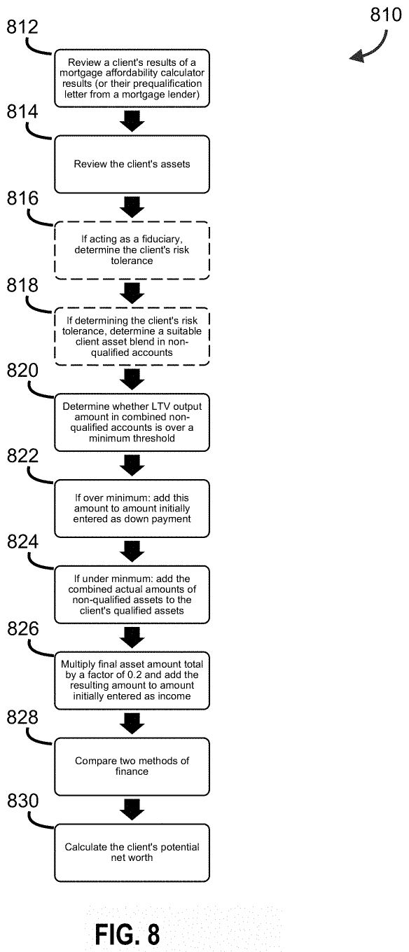

FIG. 8 is a flowchart showing an exemplary method 810 for comparing a client's net worth based on conventional methods vs. methods described herein, according to aspects of the present teachings. As shown in FIG. 8, some embodiments may include steps substantially similar to the steps of the exemplary method shown in FIG. 7. To avoid unnecessary repetition, this section will not re-describe those steps in detail. However, as shown in FIG. 8, the present exemplary method may go further to calculate the client's potential net worth. This calculation is described in further detail below.

As shown in FIG. 8, the method 810 may include a first step 812 of reviewing the results of a mortgage affordability calculator for a client, or the client's prequalification letter from a mortgage lender; a second step 814 of reviewing the client's assets, an optional third step 816 of determining the client's risk tolerance, if acting as a fiduciary; if performing the optional third step 816, then further performing an optional fourth step 818 of determining a suitable client asset blend in non-qualified accounts; a fifth step 820 of determining whether the LTV output amount in combined non-qualified accounts is over a minimum threshold; if over the minimum, then a sixth step 822 of adding this amount to the amount initially entered as the down payment; or, if under the minimum, then an alternative seventh step 824 of adding the combined actual amounts of the non-qualified assets to the client's qualified assets; an eighth step 826 of multiplying the final asset amount total by, say, a factor of 0.2 and adding the resulting amount to the amount initially entered as income; a ninth step 828 of comparing two or more methods of finance, and a tenth step 830 of calculating the client's potential net worth.

After completing the initial steps of the exemplary method shown in FIG. 8, the client or financial advisor may use the results of those steps to produce a side-by-side comparison of at least two (2) different methods of financing a home, as shown in the eight step 828 of the exemplary method 810. And, if the client has assets substantial enough, then the side-by-side comparison may show a drastic improvement in mortgage prequalification by strategically utilizing annuities and asset-backed lending as part of the client's purchasing strategy. For example, if the client may be comparing two (2) methods of financing a desired property, the client may review the difference in home values and their ability to compound over the life of or a portion of the life of the mortgage to arrive at the client's potential net worth after the applicable mortgage term.

For example, an accurate comparison may be achieved by separating the various assets into their classes, including, without limitation: initial home value, cash balances in all client bank accounts, as well as qualified and non-qualified investment account balances. In preferred embodiments, the investment calculator may automatically perform this step using client information that was input in the first step. Home values when using (a) conventional financing methods, (b) annuities and asset-backed lending, or (c) cash, may be compounded over time at an average local or national rate, less the interest rate of the mortgage (if applicable). This step may also be performed by compounding the rate over the term, and then subtracting the interest paid from the final home value after compounding the term, to arrive at the client's potential net worth in the tenth step 830 of the exemplary method 810 shown in FIG. 8.

To ensure an accurate calculation, it may be desirable to set an assumptive compounding rate for investment assets in qualified and non-qualified accounts to determine the client's potential future net worth, including the value of the property using conventional financing methods. For example, in some embodiments, the investment calculator may assume an average rate of return for a normal investor based on their blend and the results of historic studies on return capture. In others, it may be inputted manually by the client or financial advisor into the calculator. Allowing the investments to compound at a given rate and then combining them with the historic local or national growth rates on home appreciation or a manually input rate on both a lesser or greater home value may provide significant differences to the client's net worth over the term being considered.

On the other hand, for investments utilizing annuities and asset-backed lending as part of a client's purchasing strategy, it may be desirable to use the historical rate of return, net of fees, for the appropriate blend. If the client's assets in non-qualified accounts have been used to generate an additional down payment, then it may be appropriate to incorporate the interest rate drag from an asset-backed lending (ABL) line of credit on an affected proportion. Consider, for example, a client having $200,000 in non-qualified assets and an LTV of fifty percent (50%). This would allow the use of $100,000 as an additional down payment. If the interest rate on the ABL is five percent (5%) and the growth rate for the assets net of advisor fees is seven percent (7%), then $100,000 would be growing at seven percent (7%), while the fifty percent (50%) of assets in the ABL would have a drag of five percent (5%) from the line of credit interest rate, resulting in a two percent (2%) net positive compounding rate of growth on the effected assets and an average net positive rate of return on the total account of four-and-a-half percent (4.5%). These numbers are all for illustration purposes only.

For assets in a qualified account used to generate additional income for home approval, it may be suitable to subtract the assets used for insurance products and add them back into investment accounts at a desired rate based on a suitable withdrawal schedule. For example, if the client has $200,000 in their qualified account, the client may use $100,000 to purchase an annuity with a fifteen percent (15%) free withdrawal rate to provide an additional $15,000 annual income for the client. Then, after the first year of receiving this income from the annuity, it may be appropriate for the client to add this $15,000 back into their portfolio and attribute the desired interest rate to the now $115,000 held in their qualified account outside of the annuity. An additional $15,000 may be added in the second year, and each year after that, until the base of the account reaches the original amount of $200,000, not including gains.

The product referenced here actually only carries a surrender charge for three (3) years, at which time the client or the advisor on the client's behalf may remove the remainder of any assets still held in the annuity and place them back into the blends in the client's qualified or non-qualified account. This strategy may thus provide the $15,000 for the three (3) years required for underwriting, and result in $55,000 plus gains or dividends remaining in the annuity that would then be returned to the main account in one lump sum after the third year. After performing these calculations, a next step may include combining the compounded asset totals for each purchase method and compare the results. In preferred embodiments, the investment calculator may perform these steps automatically.

Several other calculations may be performed in this step as well. For example, the client or financial advisor may also assign a growth rate to homes or properties, which may then compounded through the given period or mortgage term. Additionally, it may be useful to assign corresponding rates of return on either cash or investments based on their blend using historic numbers or any other suitable method. All of these may then be combined to demonstrate the client's ending potential net worth. This includes the amount of time that a given amount may be held in an annuity and accumulating a lesser return or likewise may being be as collateral for an asset-backed line of credit and thus earning the return minus the interest rate drag.

4. Viability as Investment Property

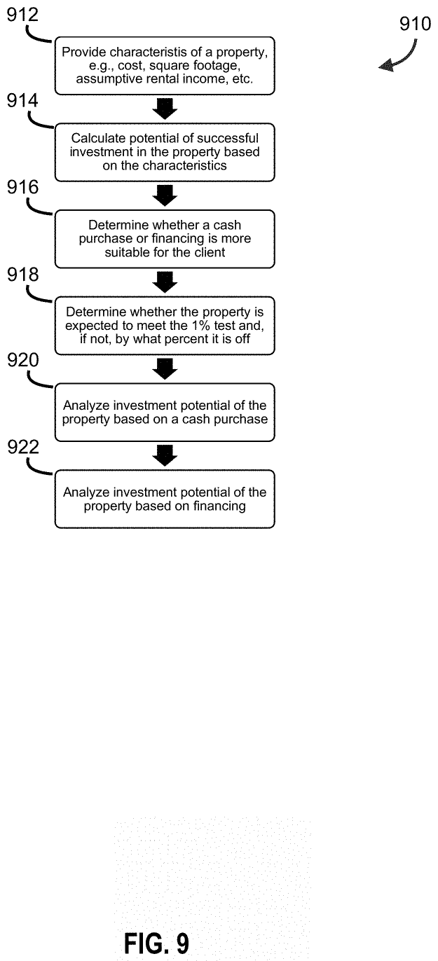

FIG. 9 is a flowchart showing an exemplary method 910 for understanding the use of certain real property as an investment, according to aspects of the present disclosure. In embodiments wherein the desired property may be used as a rental property, a first step 912 may include inputting or considering the various aspects of the property. In such embodiments, a second step 914 may include using an investment calculator to determine the total cost of the house, i.e., the purchase price plus the estimated cost of expected repairs plus the cost of desired upgrades, insurance, etc. A third step 916 may include determining whether a cash purchase or financing may be more suitable for the client. A fourth step 918 may include determining whether the property may be expected to meet the widely-used one percent (1%) test, and by how much may it surpass or fail. A fifth step 920 may entail analyzing the investment potential of the property based on a cash purchase, and a sixth step 922 may entail doing the same if the property were to be financed.

More specifically, the first step 912 of the method 910 may include inputting or considering the various relevant aspects of the property, such as cost, square footage, assumptive rental income, comparable cost, comparable rental income, cost of estimated repairs, and/or cost of planned upgrades. The second step 914 may then include performing several calculations using the investment calculator, such as, but not limited to determining the total cost of the home by adding the purchase price to estimated repair costs and upgrade costs. Next would be subtracting the total cost from the expected income to determine an estimated return on investment (ROI). This may allow for analysis of the estimated income and comparable income from either a benchmark or different property to determine rent favorability. For example, comparing the cost per square foot by the comparable cost per square foot may provide a breakdown of the potential for the property to be a successful investment for the client.

In some embodiments, a third step 916 may include inputting the client's financial information to determine the most suitable manner in which to structure the purchase of the home. For example, this step may include comparing an all-cash purchase to financing using the investment calculator. In some embodiments, a fourth step 918 may include determining whether the property may be expected to meet the one percent (1%) test, i.e., the ability of a property to demand and receive one percent (1%) of the total purchase price per month in rental income, and by how much. For example, if a property costs $100,000, then the rental income would need to be at least $1,000 per month in order to pass the one percent (1%) test. It may also be useful to determine by how much the one percent (1%) test may be either passed or failed and by what percentage. In preferred embodiments, the investment calculator may perform the fourth step automatically.

In some embodiments, the investment calculator may provide at least one breakdown of the property based on different purchasing options during the fifth step 920 of the method 910 shown in FIG. 9. For example, a breakdown may include the total cost, total expected ROI, whether the property meets the one percent (1%) test, and by how much does the property surpass or fall short of the one percent (1%) test. In some embodiments, the investment calculator may provide comparisons of how the property may be competitive per square foot, and in light of the total price plus expected annual appreciation or current rate of return. In some embodiments, the investment calculator may determine the capitalization rate and cash flow for each method of purchase. Specifically, it may be appropriate to subtract from the expected annual income the following values: a five-to-ten percent (5-10%) vacancy rate, property taxes, and/or maintenance costs to determine the net annual income—then, divide the net annual income by the purchase price of the property to determine the CAP rate.

Additionally, the CAP rate and a few other metrics that may be commonly looked at by real estate investors may be taken into account and thus properties may be compared side-by-side. In some embodiments, this may be done before deciding which may be the potentially best way to acquire the property, either cash or finance, or which combination of the two. Additionally, there may be certain financing and purchasing options available on one property or property type but not another. Such may be the case if a property had the potential to be owner-financed or a building being considered was in one jurisdiction or another. Comparing a single family home to a larger residential multifamily property, or even comparing a duplex to a fourplex, when using the same lender could create differences in purchase type available. These differences may be taken into account when using the methods disclosed herein and a review, rating, comparison or recommendation may be completed by or with the calculator according to aspects of the present teachings.

### Advantages, Features, Benefits

The different embodiments of methods for optimizing returns for home buyers and real estate investors described herein may provide several advantages over previous methods. For example, the illustrative embodiments described herein may potentially enable a client to qualify for a better mortgage, take out a larger home loan, generate a guaranteed income, enjoy greater liquidity, and achieve a higher net worth. Additionally, and among other benefits, illustrative embodiments described herein allow for financial advisors and similar service providers to quickly and accurately provide clients with a clear roadmap to building a desired net worth as it relates to home ownership, analyzed in light of the client's personal risk tolerance, financial goals, investment timelines, tax considerations, current assets, and so on.

Furthermore, by utilizing annuities and asset-backed lending as part of a client's real estate purchasing strategy, clients may enjoy potentially lower negative interest rates, higher returns, greater asset diversification, increased real estate purchasing power, lower taxes and fees, greater tax efficiency, some degree of potential insurance or protection on their assets, and/or more asset liquidity and flexibility—thereby potentially resulting in more money and a higher net worth for the client. And, the illustrative embodiments described herein may be used for multiple purposes, such as determining the amount of home that a client can afford or maximizing the loan amount that a client may be prequalified for, comparing the client's potential net worth if the client were to make an all-cash purchase or take out a mortgage. No known methods can produce these results. However, not all embodiments described herein provide the same advantages or the same degree of advantage.

What is claimed is:

1. A method for maximizing home loan qualification, comprising the steps of:
reviewing a prequalified mortgage amount of a user;
reviewing at least one financial asset of the user that serves as a basis for determining the prequalified mortgage amount;
determining a minimum threshold for a loan-to-value output amount of the user;
calculating a final asset amount of the user based on whether the loan-to-value output amount is above or below the minimum threshold; and
calculating a new qualified mortgage amount of the user by multiplying the final asset amount of a user by a suitable factor and adding the at least one financial asset of the user.

2. The method of claim 1, wherein the at least one financial asset of a user includes an income of the user suitable for determining the prequalified mortgage amount.

3. The method of claim 2, wherein the at least one financial asset of a user further includes a bank account of the user, an investment account of the user, an annuity of the user, and an insurance policy of the user.

4. The method of claim 1, further comprising a step of determining a risk tolerance of the user.

5. The method of claim 4, further comprising a step of using the risk tolerance to determine a suitable asset blend in a non-qualified account of the user.

6. The method of claim 1, further comprising a step of reviewing at least one of an account holding of a user, an investment portfolio of a user, or an asset blend of the user.

7. The method of claim 1, further comprising a step of producing a comparison of at least two different methods of financing a home.

8. A method for maximizing mortgage approval, comprising the steps of:
determining whether a user has at least one initial asset sufficient to purchase a desired property in cash;
determining whether the user is capable of qualifying for a mortgage on the desired property;
determining an end value of the desired property compounding over a term of the mortgage;
identifying an interest rate of the mortgage, a monthly payment of the mortgage, and a total number of payments on the mortgage for the desired property, over the term of the mortgage;
estimating an amount of tax savings based on an anticipated amount of tax deductions for the interest rate of the mortgage, over the term of the mortgage;
compounding the amount of tax savings at a suitable rate associated with a portfolio asset blend of the user; and
identifying a total mortgage dollar amount anticipated to be paid over the life or a portion of the term of the mortgage.

9. The method of claim 8, further comprising a step of compounding the at least one initial asset of the user over the term of the mortgage.

10. The method of claim 8, further comprising a step of identifying an estimated amount of property taxes due on the desired property over the term of the mortgage.

11. The method of claim 8, further comprising a step of collecting a set of financial information from the user in order to run a mortgage report for the user.

12. The method of claim 9, wherein the mortgage report serves as a basis for determining the interest rate, monthly payment, and the total number of payments on the mortgage for the desired property.

13. The method of claim 9, further including a step of using the mortgage report to determine whether it is more financially prudent for the user to complete a purchase of the desired property outright or finance at least some of the purchase.

14. A method for increasing real estate loan approval, comprising the steps of:
determining at least one financial asset held in at least one investment account of a user;
using the at least one financial asset of the user to determine whether the user is capable of receiving an approval for an intended use of a desired property;
using asset-backed lending to improve the approval for the intended use of the desired property; and
maintaining the least one financial asset of the user within the at least one investment account of the user for the intended use on the desired property.

15. The method of claim 14, wherein the set of financial data of the user further includes one or more of annual income, a desired down payment, or an amount of monthly or annual expenses.

16. The method of claim 14, wherein the intended use of the desired property includes purchasing, renting, or leasing the desired property.

17. The method of claim 14, further comprising a step of at least temporarily placing the at least one financial asset into an annuity to provide guaranteed income for the user.

18. The method of claim 17, wherein the guaranteed income is annuity income determined by a contract between a carrier of the annuity and the user.

19. The method of claim 17, further comprising a step of removing the at least one financial asset from the annuity and placing the at least one financial asset into a suitable blend in a qualified or non-qualified account of the user.

20. The method of claim 17, further comprising a step of combining a compounded asset total for each of at least two different purchase methods to thereby compare the at least two different purchase methods.
